(19) United States
(12) Patent Application Publication
(10) Pub. No.: US 2020/0173466 A1
(43) Pub. Date: Jun. 4, 2020

(54) REMOVABLE CABLE FOR AN ACTUATOR

(71) Applicant: Johnson Controls Technology Company, Auburn Hills, MI (US)

(72) Inventors: Parag Jivanrao Bhongade, Wardha (IN); Amol Ramdas Vetal, Pune (IN); Bhausaheb Uttam Pawar, Pune (IN); Shivchandra Venkatrao Nagime, Latur (IN)

(73) Assignee: Johnson Controls Technology Company, Auburn Hills, MI (US)

(21) Appl. No.: 16/208,774

(22) Filed: Dec. 4, 2018

(51) Int. Cl. F15B 13/08; H01R 25/00; H01R 13/639

(52) U.S. Cl. CPC F15B 13/0857; F15B 15/149; H01R 13/639; H01R 25/003

(57) ABSTRACT

An actuator is usable in an airside system, waterside system, building management system, or HVAC system. The actuator includes a housing. The housing has a socket with an interior passage that includes a male connector. The socket may extend outwardly from the housing. The actuator also includes an overmolded cable sized to fit in the interior passage and including a female connector that receives the male connector within the socket. The actuator includes a coupling device that surrounds the overmolded cable and is coupled to the socket and maintains an electrical connection between the male connector and female connector.

### BACKGROUND

The present disclosure relates generally to actuators in a heating, ventilating, or air conditioning (HVAC) system and more particularly to assembly of an enclosure for an HVAC actuator.

HVAC actuators are used to operate a wide variety of HVAC components, such as air dampers, fluid valves, air handling units, and other components that are typically used in HVAC systems. For example, an actuator may be coupled to a damper in an HVAC system and may be used to drive the damper between an open position and a closed position. An HVAC actuator typically includes a cable which provides and/or receives electrical signals to or from the HVAC actuator. These signals may power or control the HVAC actuator.

During assembly, the cable is typically electrically coupled to the HVAC actuator internally. Accordingly, the actuator housing is opened up to expose an internal compartment, the cable is fed through an opening, and is then coupled to the HVAC actuator. This can be time consuming and therefore require more assembly lead time.

### SUMMARY

At least one embodiment relates to an actuator. The actuator includes a main body housing comprising a socket extending outwardly from the main body, the socket having an interior passage including a male connector. The actuator includes an overmolded cable sized to fit in the interior passage and including a female connector to receive the male connector within the socket. The actuator includes a coupling device surrounding the overmolded cable and coupled to the socket so as to maintain an electrical connection between the male connector and female connector.

In some embodiments, the socket includes a threaded exterior surface. The coupling device includes an interior surface having threads configured to engage the threaded exterior surface to couple the coupling device to the socket.

In some embodiments, the coupling device further includes a first portion coupled to the socket and a second portion configured to receive a conduit for insulating the overmolded cable.

In some embodiments, the actuator further includes an o-ring fitting configured to surround the female connector and insulate the male connector and female connector.

In some embodiments, the female connector of the overmolded cable further includes a guide, and the interior passage of the socket further includes a tab configured to fit in the guide. The tab and guide being used to orient the female connector with respect to the male connector.

Another embodiment relates to a method of assembling an actuator. The method includes inserting an overmolded cable including a female connector into a socket extending outwardly from a housing for an actuator, the socket including an interior passage, having a male connector, and an exterior surface. The method includes coupling a coupling device surrounding the overmolded cable to the socket to maintain an electrical connection between the male connector and female connector.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a drawing of a building equipped with a heating, ventilating, or air conditioning (HVAC) system and a building management system (BMS), according to an exemplary embodiment.

FIG. 2 is a schematic diagram of a waterside system which may be used to support the HVAC system of FIG. 1, according to an exemplary embodiment.

FIG. 3 is a block diagram of an airside system which may be used as part of the HVAC system of FIG. 1, according to an exemplary embodiment.

FIG. 4 is a block diagram of a BMS which may be implemented in the building of FIG. 1, according to an exemplary embodiment.

FIG. 5 is a view of an actuator which may be used in the HVAC system of FIG. 1, the waterside system of FIG. 2, the airside system of FIG. 3, or the BMS of FIG. 4 to control an HVAC component, according to an exemplary embodiment.

FIG. 6 is an exploded view of the actuator of FIG. 5, according to an exemplary embodiment.

FIG. 7 is a view of the actuator of FIG. 5 and an overmolded cable, according to an exemplary embodiment.

FIG. 8 is a flowchart of a process of assembling the HVAC actuator of FIG. 5, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, an HVAC actuator is shown, according to an exemplary embodiment. The actuator may be a damper actuator, a valve actuator, a fan actuator, a pump actuator, or any other type of actuator that can be used in an HVAC or other system.

The actuator includes a housing. The housing has a socket with an interior passage that includes a male connector. The socket may extend outwardly from the housing. The actuator also includes an overmolded cable sized to fit in the interior passage and including a female connector that receives the male connector within the socket. The actuator includes a coupling device that surrounds the overmolded cable and is coupled to the socket and maintains an electrical connection between the male connector and female connector.

The aspects described herein may decrease the time of assembly through use of the outwardly extending socket. Additionally, through use of an o-ring fitting and the coupling device, the actuator may satisfy various requirements, such as Ingress Protection IP54. Additionally, different coupling devices may be used for the same actuator to satisfy different needs in different countries, which may decrease production and design costs. Various other benefits of the present disclosure will become apparent as follows.

### Building Management System and HVAC System

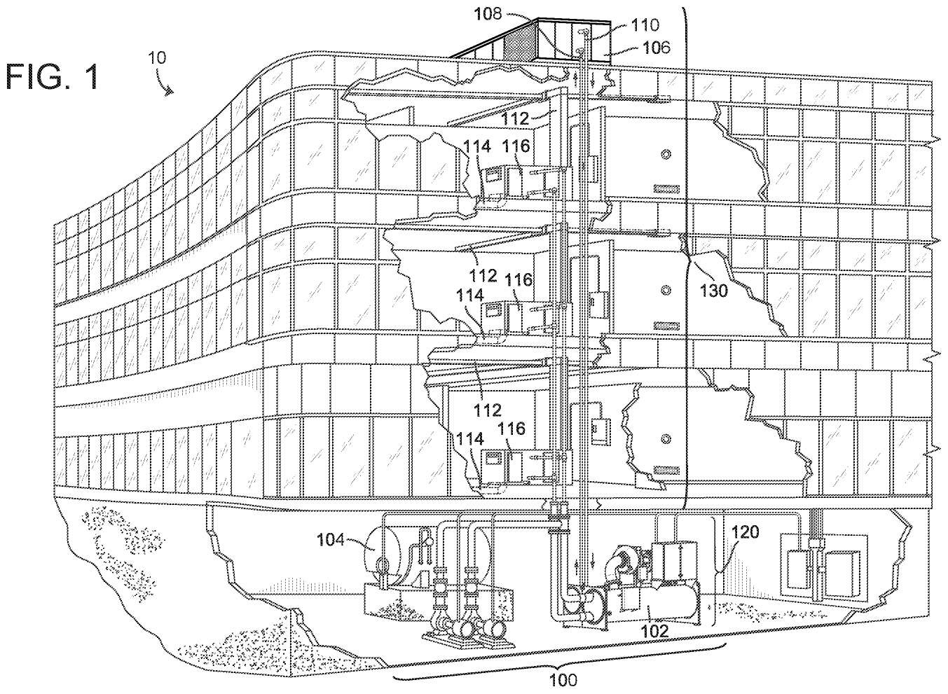

Referring now to FIGS. 1-4, an exemplary building management system (BMS) and HVAC system in which the systems and methods of the present disclosure may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS may include, for example, an HVAC system, a security system, a lighting system, a fire alerting system, and any other system that is capable of managing building functions or devices, or any combination thereof

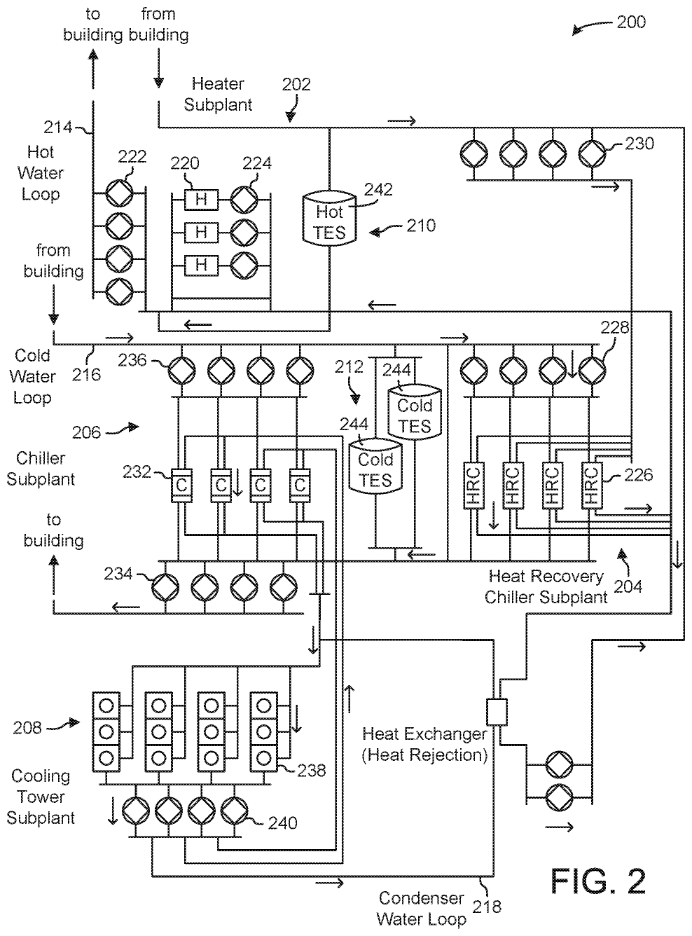

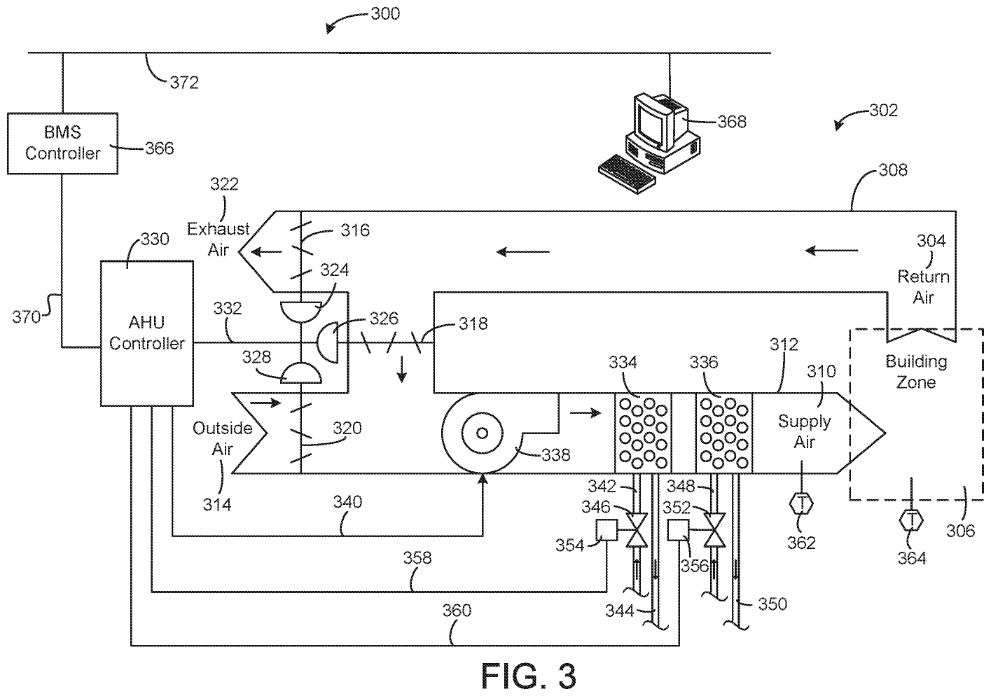

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that may be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve set point conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type AHU 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that may be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that may be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a BMS controller 366 and a client device 368. BMS controller 366 may include one or more computer systems (e.g., servers, supervisory controllers, subsystem controllers, etc.) that serve as system-level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that may be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

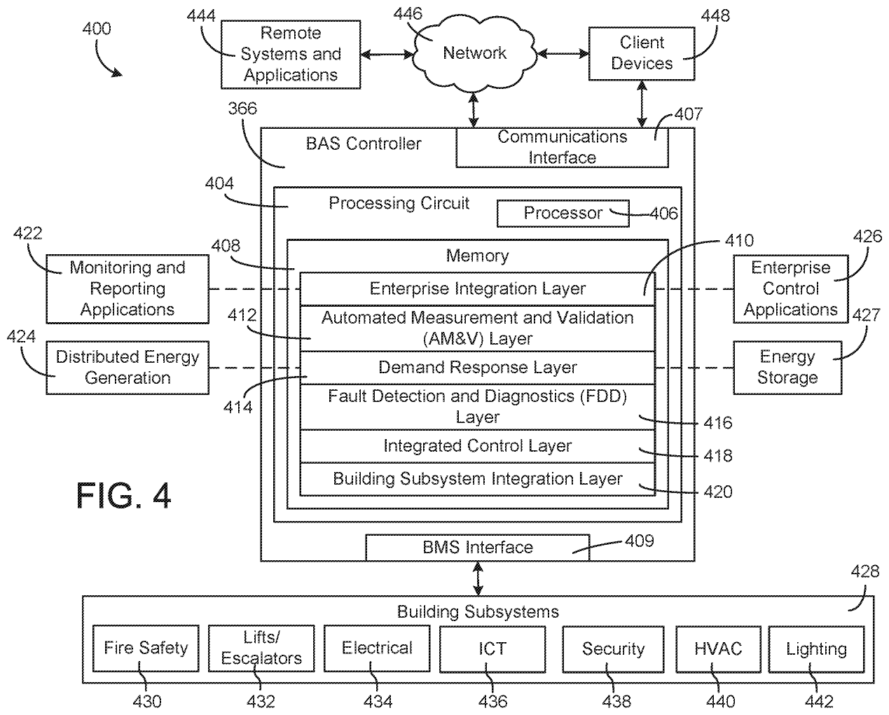

Referring now to FIG. 4, a block diagram of a BMS 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 may include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include any number of chillers, heaters, handling units, economizers, field controllers, supervisory controllers, actuators, temperature sensors, and/or other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407 and 409 may be or may include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407 and 409 may be direct (e.g., local wired or wireless communications) or via a communications network 446 (e.g., a WAN, the Internet, a cellular network, etc.). For example, interfaces 407 and 409 may include an Ethernet card and port for sending and receiving data via an Ethernet-based communications link or network. In another example, interfaces 407 and 409 may include a Wi-Fi transceiver for communicating via a wireless communications network. In another example, one or both of interfaces 407 and 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof may send and receive data via interfaces 407 and 409. Processor 406 may be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that may exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 may work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses may include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions may specify which equipment may be turned on or off in response to particular demand inputs, how long a system or piece of equipment should be turned off, what setpoints may be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 may integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions may be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and AM&V layer 412. Integrated control layer 418 may be configured to provide calculated inputs (e.g., aggregations) to these higher levels based on outputs from more than one building subsystem.

AM&V layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

FDD layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes may be examined by FDD layer 416 to expose when the system begins to degrade in performance and alert a user to repair the fault before it becomes more severe.

### HVAC Actuator

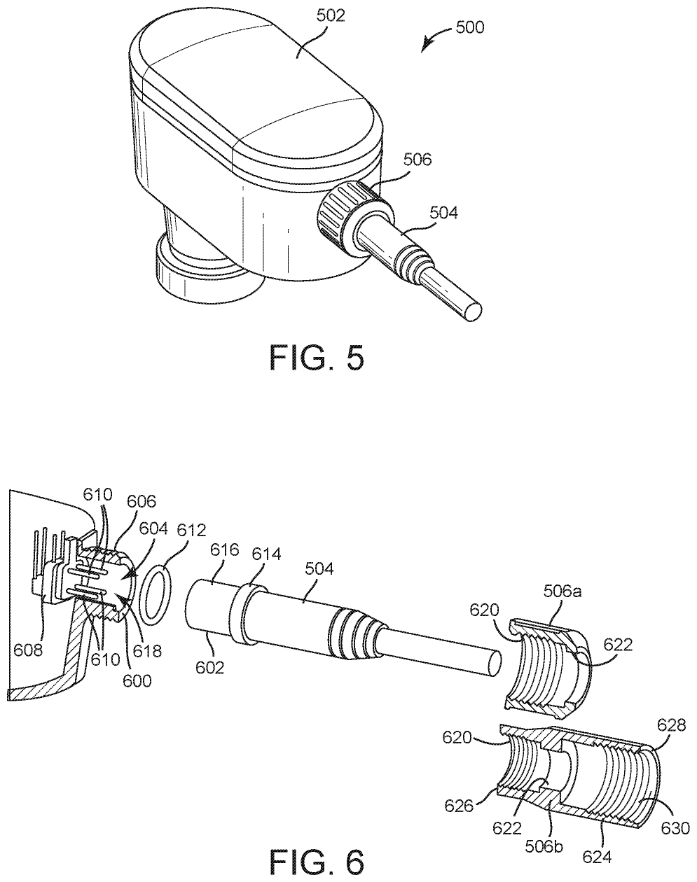

FIG. 5 is a view of an actuator 500 according to an exemplary embodiment. In some implementations, actuator 500 may be used in HVAC system 100, waterside system 200, airside system 300, or BMS system 400, as described with reference to FIGS. 1-4. For example, actuator 500 may be a damper actuator, a valve actuator, a fan actuator, a pump actuator, or any other type of actuator that may be used in an HVAC system or BMS. In various embodiments, actuator 500 may be a linear actuator (e.g., a linear proportional actuator), a non-linear actuator (e.g., a rotary actuator), a spring return actuator, or a non-spring return actuator.

Actuator 500 is shown to include a housing 502. Housing 502 may contain the mechanical and processing components of actuator 500 when assembled. In some embodiments, housing 502 contains a brushless direct current (BLDC) motor and a processing circuit configured to provide a pulse width modulated (PWM) DC output to control the speed of the motor. In other embodiments, the housing 502 may contain other types of motors that are controllable (e.g., by the various processing components of the actuator 500 and/or the HVAC or BMS system 100, 400).

Actuator 500 may generally provide a mechanical output to various devices in the HVAC, waterside, airside, or BMS systems 100, 200, 300, 400. The actuator 500 may be a rotary actuator, a linear actuator, etc. Accordingly, the actuator 500 may provide different types of force outputs depending on configuration.

Actuator 500 may receive power and/or control inputs from a remote source. In some embodiments, actuator 500 may include a cable for receiving power or control inputs. For instance, the actuator 500 may receive inputs and/or power from an overmolded cable 504. The overmolded cable 504 may be attached to the housing 502 of the actuator 500 via a coupling device 506. The coupling device 506 may secure the overmolded cable 504 to the housing 502, as discussed in greater detail below.

Referring now to FIG. 6, an exploded view of the actuator 500 is shown, according to an exemplary embodiment.

The housing 502 is shown to include a socket 600. The socket 600 may receive the overmolded cable 504. Specifically, the socket 600 may be sized to receive a female connector 602 of the overmolded cable 504. The socket 600 may include an interior passage 604 and an exterior surface 606. The female connector 602 of the overmolded cable 504 may be guided into the interior passage 604 of the socket 600. The socket 600 may include a male connector 608. The male connector 608 may be electrically connected to the female connector 602. The male connector 608 may include a number of pins or prongs 610 which are inserted into the female connector 602. While four prongs 610 are shown, the male connector 608 may include any number of prongs 610 (e.g., more or fewer prongs 610). Accordingly the present disclosure is not limited to the number of prongs 610 depicted in FIG. 6. The male connector 608 may be electrically coupled to internal circuitry within the housing 502. Accordingly, the male connector 608 may provide signals received from the female connector 602 to the internal circuitry for powering the actuator 500, controlling various motors or other outputs from the actuator 500, etc. Additionally, the actuator 500 may provide signals to an external source (e.g., one or more components in the HVAC, airside, waterside, or BMS system 100, 200, 300, 400) via the male/female connectors 608, 602.

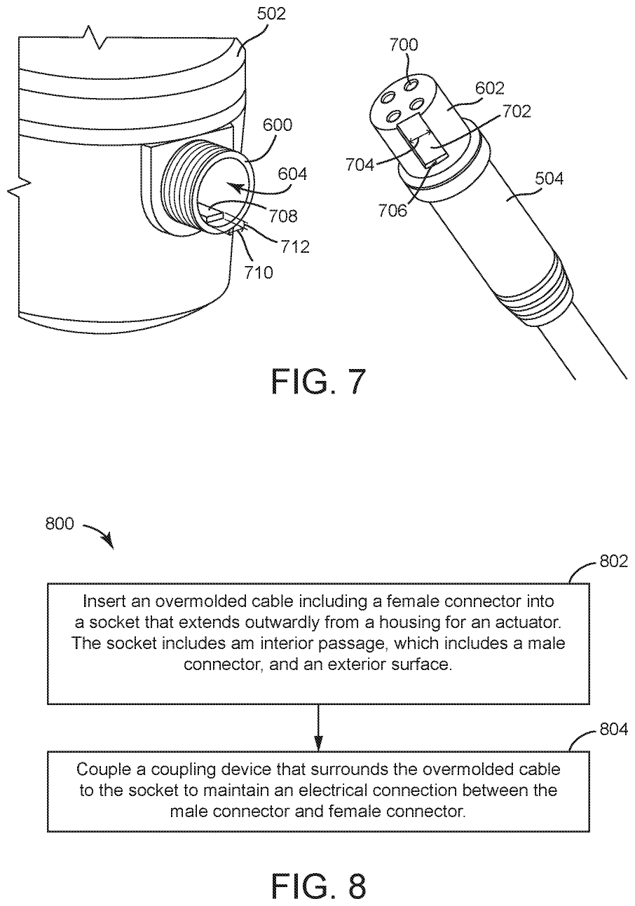

Referring now to FIG. 7, in some embodiments, the female connector 602 may have a particular orientation for which to connect to the male connector 608. Specifically, FIG. 7 shows a view of the actuator 500 and overmolded cable 504, according to an exemplary embodiment.

As can be best seen in FIG. 7, the female connector 602 may include a number of prong passages 700 (e.g., pin receptacles, etc.). Each of the prong passages 700 may correspond to a conductor (e.g., wire) within the overmolded cable 504. Additionally, each prong passage 700 may correspond to a particular prong 610 of the male connector 608. Accordingly, each prong 610 may provide signals (or receive signals) from a particular conductor in the overmolded cable 504. When the female connector 602 is not properly oriented, each prong 610 will not be electrically coupled to the proper conductor within the overmolded cable 504.

The female connector 602 may include a guide 702. The guide 702 may be located along a perimeter of the female connector 602. The guide 702 may run the length of the female connector 602 (e.g., from front to back as shown in FIG. 7). The guide 702 may have a width 704 and a depth 706 (e.g., forming a recessed portion).

The socket 600 may include a tab 708 located within the interior passage 604. The tab 708 may be located along the perimeter of the interior passage 604. The tab 708 may have a width 710 and thickness 712 that correspond to the width 704 and depth 706 of the guide 702. For instance, the width 710 and thickness 712 of the tab 708 and the width 704 and depth 706 of the guide 702 may be substantially the same such that the tab 708 fits into the guide 702. The tab 708 and guide 702 may be used as a poka-yoke feature for properly aligning the female connector 602 with respect to the male connector 608.

Referring back to FIG. 6, in some embodiments, the overmolded cable 504 may include an o-ring fitting 612. The o-ring fitting 612 may be sized to surround the female connector 602. The female connector 602 may be pushed through the o-ring fitting 612 until the o-ring fitting 612 is pressed up against a stopper 614 for the overmolded cable 504. The o-ring fitting 612 may be constructed of rubber or some other hydrophobic material. When the female connector 602 and male connector 608 are connected to one another, the o-ring fitting 612 may be positioned on an exterior surface 616 of the female connector 602 adjacent to the stopper 614 to prevent water (or other external elements) from entering in the space between the exterior surface 616 of the female connector 602 and an interior surface 618 of the interior passage 604.

When the female connector 602 and male connector 608 are electrically coupled to one another, the coupling device 506 may secure the overmolded cable 504 to the housing 502. FIG. 6 shows two example coupling devices 506a and 506b. The first coupling device 506a may be a coupling device 506 that secures the overmolded cable 504 to the housing 502. The second coupling device 506b may be a coupling device that both secures the overmolded cable 504 to the housing 502 and connects to a conduit.

Each of the coupling devices 506a, 506b may include a feature which engages with the socket 600. For instance, the coupling devices 506a, 506b may include an interior surface 620. The interior surface 620 of the coupling devices 506a, 506b may each include threads which engage the exterior surface 606 of the socket 600 (which may also be threaded). The coupling devices 506a, 506b may then be screwed onto the socket 600 with a neck 622 of the coupling devices 506a, 506b pressed up against the stopper 614 to secure the overmolded cable 504 to the housing 502. Accordingly, the coupling devices 506a, 506b may generally maintain the connection of the female connector 602 and male connector 608 by securing the overmolded cable 504 to the housing 502 (through being screwedly coupled to the socket 600).

In some embodiments, the overmolded cable 504 may be fed through a conduit (not shown). The conduit may insulate the overmolded cable 504 from water, machinery, or other elements that may damage or cut the overmolded cable 504. Such conduits are used in some countries, such as many North American countries. However, some countries, such as several European and Asian countries, may not typically use the conduits. Accordingly, the present disclosure is not limited to either arrangement.

In arrangements where the conduits are used, coupling device 506b may be used for coupling the overmolded cable 504 to the housing 502. Specifically, coupling device 506b includes an adapter 624 for coupling to a conduit. In these embodiments, the coupling device 506b may include a first side 626 and a second side 628. The first side 626 may be adjacent the housing 502 when the coupling device 506b is coupled to the socket 600. The second side 628 may be opposite the first side 626 with respect to the neck 622. The adapter 624 may be located adjacent to the second side 628 with an opening 628 located along the second side 628. The opening 628 may be sized to receive the conduit, and may include a threaded interior surface 630 which engages a threaded exterior surface of the conduit to securely couple the conduit to the coupling device 506b.

While threaded surfaces and corresponding threads are disclosed, the coupling devices 506a, 506b may include other features which engage with the socket 600 to secure the coupling devices 506a, 506b to the socket 600. Accordingly, the present disclosure is not limited to the specific implementation of threads and includes other features for securely coupling the coupling devices 506a, 506b to the socket 600.

Where conduits are not used for insulating the overmolded cable 504, the overmolded cable 504 may be secured to the housing 502 via coupling device 506a. Accordingly, coupling devices 506a, 506b may be interchangeable with respect to coupling the overmolded cable 504 to the housing 502, but may be selectively used depending on whether a conduit insulates the overmolded cable 504.

As a result of the aspects described herein, the actuator 500 may satisfy various standards (e.g., ingress protection IP54, for instance). Additionally, the aspects described herein provide a relatively simple way of assembling an actuator relative to other actuators, thereby reducing lead time.

### Assembly of the HVAC Actuator

An example process of assembling the HVAC actuator 500 will be described with reference to FIG. 8. Specifically, FIG. 8 shows a flowchart of a process 800 of assembling the HVAC actuator 500, according to an exemplary embodiment.

The process 800 is shown to inserting the overmolded cable 504 including the female connector 602 into the socket 600 that extends outwardly from the housing 502 of the actuator 500 (step 802). The socket 600 includes the interior passage 604 and the exterior surface 606. The interior passage 604 includes the male connector 608.

In some embodiments, the o-ring fitting 612 may be positioned on the exterior surface 616 of the female connector 602 adjacent to the stopper 614 prior to the overmolded cable 504 being inserted into the socket 600. In these embodiments, the o-ring fitting 612 may further inhibit or prevent ingress of water or other substances from entering the space between the exterior surface 616 of the female connector 602 and the interior surface 618 of the socket 600.

In some embodiments, the overmolded cable 504 may only be inserted into the socket in a particular orientation. For instance, in some embodiments, the female connector 602 may include a guide 702 and the socket 600 may include a corresponding tab 708. The guide 702 and tab 708 may act as a poka-yoke feature for orienting the female connector 602 with respect to the male connector 608. The guide 702 may be sized to receive the tab 708 such that the tab 708 fits within the guide 702.

The process 800 is shown to include coupling the coupling device 506 that surrounds the overmolded cable 504 to the socket 600 (step 804). The coupling device 506 may maintain an electrical connection between the male connector 608 and female connector 602.

In some embodiments, the exterior surface 606 of the socket 600 may be threaded, and the interior surface 620 of the coupling device 506 may have threads which engage the threaded exterior surface 606. In these embodiments, the coupling device 506 may be screwed to the socket 600 to secure the overmolded cable 504 to the housing 502 and thereby maintain the electrical connection between the male connector 608 and the female connector 602.

In some embodiments, the overmolded cable 504 may be fed through a conduit. In these embodiments, the coupling device 506b may be coupled to the socket 600. The coupling device 506b may have a first side 626 which is adjacent to the housing 502, and a second side 628. The coupling device 506b may include an adaptor 624 with an opening along the second side 628. The adaptor 624 may be sized to receive the conduit, and may include features (e.g., threads, for instance) which securely couple the conduit to the coupling device 506b.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the HVAC actuator and assembly thereof as shown in the various exemplary embodiments is illustrative only. Additionally, any element disclosed in one embodiment may be incorporated or utilized with any other embodiment disclosed herein. For example, the coupling device of the exemplary embodiment described in at least paragraph(s) [0081]-[0082] may be incorporated in the actuator of the exemplary embodiment described in at least paragraph(s) [0079]-[0080]. Although only one example of an element from one embodiment that can be incorporated or utilized in another embodiment has been described above, it should be appreciated that other elements of the various embodiments may be incorporated or utilized with any of the other embodiments disclosed herein.

1. An actuator, comprising:
a housing comprising a socket extending outwardly from a main body of the housing, the socket having an interior passage including a male connector;
an overmolded cable sized to fit in the interior passage and including a female connector to receive the male connector within the socket; and
a coupling device surrounding the overmolded cable and coupled to the socket so as to maintain an electrical connection between the male connector and female connector.

2. The actuator of claim 1, wherein:
the socket includes a threaded exterior surface; and
the coupling device includes an interior surface having threads configured to engage the threaded exterior surface to couple the coupling device to the socket.

3. The actuator of claim 1, wherein the coupling device further comprises:
a first portion coupled to the socket; and
a second portion configured to receive a conduit for insulating the overmolded cable.

4. The actuator of claim 1, further comprising:
an o-ring fitting configured to surround the female connector and insulate the male connector and female connector.

5. The actuator of claim 1, wherein the female connector of the overmolded cable further includes a guide, and the interior passage of the socket further includes a tab configured to fit in the guide, the tab and guide being used to orient the female connector with respect to the male connector.

6. A method of assembling an actuator, comprising:
inserting an overmolded cable including a female connector into a socket extending outwardly from a housing for an actuator, the socket including an interior passage having a male connector, and an exterior surface; and
coupling a coupling device surrounding the overmolded cable to the socket to maintain an electrical connection between the male connector and female connector.

7. The actuator of claim 1, wherein the female connector of the overmolded cable further includes a guide, and the interior passage of the socket further includes a tab configured to fit in the guide, the tab and guide being used to orient the female connector with respect to the male connector.

8. The actuator of claim 1, wherein the coupling device includes a neck and the overmolded cable includes a stopper.

9. The actuator of claim 8, wherein the coupling device is coupled to the socket with the neck pressed against the stopper.

10. The actuator of claim 9, wherein the stopper is sandwiched between the neck and the socket.

11. The actuator of claim 1, wherein the male connector includes four prongs, and wherein the female connector includes four prong passages configured to form an electrical connection with the four prongs.

12. The actuator of claim 11, wherein the overmolded cable further includes a guide and the interior passage further includes a tab which engages the guide and orients the four prongs of the male connector and the four prong passages of the female connector.

13. The method of claim 6, wherein coupling the coupling device to the socket comprises:
coupling, by screwing threads on an interior surface the coupling device to a threaded exterior surface of the socket, the coupling device surrounding the overmolded cable to the socket to maintain the electrical connection between the male connector and the female connector.

14. The method of claim 6, wherein coupling the coupling device to the socket comprises:
coupling a first portion of the coupling device to the socket to maintain an electrical connection between the male connector and female connector, wherein the coupling device includes a second portion configured to receive a conduit for insulating the overmolded cable.

15. The method of claim 14, further comprising:
coupling the conduit to the second portion of the coupling device.

16. The method of claim 6, further comprising:
fitting an o-ring fitting around the female connector to insulate the male connector and female connector prior inserting the overmolded cable into the socket.

17. The method of claim 6, wherein inserting the overmolded cable into the socket comprises:
inserting the overmolded cable including the female connector into the socket with a tab included in the interior passage fitting into a guide included in the overmolded cable, the guide and tab orienting the female connector with respect to the male connector.

18. The method of claim 6, wherein the coupling device includes a neck and the overmolded cable includes a stopper.

19. The method of claim 18, wherein coupling the coupling device to the socket comprises:
coupling the coupling device surrounding the overmolded cable to the socket with a neck of the coupling device pressed against a stopper of the overmolded cable.

20. The method of claim 19, wherein coupling the coupling device to the socket comprises:
coupling the coupling device surrounding the overmolded cable to the socket with the stopper of the overmolded cable sandwiched between the neck of the coupling device and the socket.
